(19) United States
(12) Patent Application Publication
(10) Pub. No.: US 2020/0016643 A1
(43) Pub. Date: Jan. 16, 2020

(54) OIL REMOVAL SYSTEM USING SUPERHEATED STEAM AND SUPERHEATED STEAM GENERATION DEVICE

(71) Applicant: MOLITEC STEEL CO., LTD., Osaka-shi, Osaka (JP)

(72) Inventors: Toshihiko TAKEMOTO, Osaka-shi (JP); Takahiro TOKAI, Osaka-shi (JP); Takuma FUKUDA, Osaka-shi (JP)

(73) Assignee: MOLITEC STEEL CO., LTD., Osaka-shi, Osaka (JP)

(21) Appl. No.: 16/485,878

(22) PCT Filed: Feb. 19, 2018
(86) PCT No.: PCT/JP2018/005713

§ 371 Date: Aug. 14, 2019

(30) Foreign Application Priority Data
Feb. 28, 2017 (JP) 2017-035752

(51) Int. Cl. B21B 45/02; B08B 3/10; C23G 5/00

(52) U.S. Cl. CPC B21B 45/0284; C23G 5/00; B08B 3/106

(57) ABSTRACT

Provided are an oil removal system and an oil removal method with which good oil removal can be achieved, and a superheated steam generation device which can be used in the execution thereof. An oil removal device imparts, from a discharge part, superheated steam obtained by a superheated steam generation device to a treatment object, which includes oil on the surface thereof. The treatment object is set so that the surface temperature thereof is cooled by a cooling part so as to be lower than the superheated steam. Dew condensation is produced on the surface of treatment object by the discharge of the superheated steam from the discharge part, and the dew condensation is blown off and removed from the surface of the treatment object by a removal part, and thereby oil on the surface is removed together with the dew condensation.

### TECHNICAL FIELD

The present invention relates to an oil removal system using superheated steam and a superheated steam generation device.

### BACKGROUND ART

As a system for removing an oil adhering to a surface of an object to be treated such as a metal work by using superheated steam, those illustrated in Patent Documents 1 to 5 are known.

Patent Document 1 discloses an oil removal system including a washing water nozzle which injects spray water from a spray-water nozzle onto a substrate immediately below saturated or superheated steam injection from a steam nozzle, peels/washes by steam explosion due to instantaneous evaporation of sprayed particles, thereby discharging/transporting peeled-off objects.

Therefore, in this system, the superheated steam was used for incurring steam explosion due to contact with water to peel/wash and was not used to remove an oil by dew condensation.

Patent Documents 2 and 3 disclose an oil removal system in which, for example, an object to be treated being stained by adhesion of machine oil is dissolved in a washing liquid such as kerosene and like, and then transported to a rinsing/drying chamber where the superheated steam is injected to the object to be treated, and volatilization removal process of a residual washing liquid is executed. In this system, the injected superheated steam scrapes off residuals containing the washing liquid by the injection force at the same time of Volatilizing/peeling-off the washing liquid, whereby the washing liquid and the residuals are removed from the object to be treated. Accordingly, in this system, the superheated steam was used for volatilization removal process of the residual washing liquid containing oil dissolved in a solvent and was not used for removal of the oil due to dew condensation.

Patent Document 4 discloses an oil removal system in which a steel plate is passed through a superheated steam sprayer, by blowing the superheated steam to the both surfaces of the steel plate, oils such as rolling oil, machine oil and the like adhering to both surfaces of the steel plate are removed by heating and vaporization. Therefore, in this system, the superheated steam was used for removal of the oil by heating and evaporation and was not used for removal of the oil by dew condensation.

Patent Document 5 discloses an oil removal system for continuously degreasing washing a surface of an object to be treated by continuously passing through the long object to be treated an inlet for the object to be treated being long to a lower part, an outlet for the object to be treated being long to an upper part, a washing and drying furnace having a superheated steam introduction port to fill the superheated steam, and from lower part to upper part of a washing chamber in the washing and drying path furnace.

The invention according to Patent Document 5 was made in order to solve a problem that, with a continuous washing method for removing oil together with the steam by blowing the superheated steam from a nozzle to an object to be treated, not only an object to be treated with low heat resistance or an object to be treated with low mechanical strength would be damaged, but also when the superheated steam blows to the entire surface of the object to be treated by using a nozzle, since uniform blowing cannot be performed, a hole opens or deformation occurs, thus the superheated steam is introduced to the washing chamber without applying the superheated steam injected from the nozzle to the object to be treated. More specifically, the system is achieved that by passing the long object to be treated through the washing chamber filled with the steam at a predetermined speed according to a heat capacity of the object to be treated from lower part to upper part, a high-temperature superheated steam taken in the oil and the like is condensed on the surface of the object to be treated introduced from the lower part, and as it goes upward, the water droplets taken in the oil and the like are evaporated, when going out from upper-part outlet, it becomes dry state, then, the stains such as grease on the surface are removed so that even the object to be treated with low heat resistance or with low mechanical strength can be uniformly washed. This system is not to directly apply the superheated steam to the object to be treated but by condensing the superheated steam taken in the oil on the surface of the object to be treated, the water droplets are evaporated with the oil and washed. Therefore, as described in the paragraph 0017 of Patent Document 5, drying is insufficient at such washing speed that the object to be treated passes through the washing chamber before the evaporation of the condensation is completed, and thus washing also becomes insufficient. On the other hand, if the washing speed is too slow, a temperature of the object to be treated gets closer to the temperature of the supplied superheated steam, and thus a heat resisting temperature may be exceeded depending on the material in some cases. As a result, adjustment to an appropriate speed in accordance with the heat capacity per unit length of the long object to be treated becomes important.

In the system of Patent Document 5, as mentioned above, conditions for favorably realizing dew condensation and perspiration of the condensation are compelled to be strict and thus, there is a concern that setting of operation conditions of the system is difficult or the system cannot handle a change in the material, shape or size of the object to be treated.

### PRIOR ART DOCUMENTS

### Patent Document

Patent Document 1: Japanese Patent Laid-Open publication No. 2007-180117
Patent Document 2: Japanese Patent Laid-Open Publication No. H6-55114
Patent Document 3: Japanese Patent Laid-Open Publication No. H6-86960
Patent Document 4: Japanese Patent Laid-Open Publication No. 2007-246936
Patent Document 5: Japanese Patent No. 4642106

### SUMMARY OF THE INVENTION

### Problem to be Solved by the Invention

The present invention has an object to provide an oil removal system and an oil removing method capable of favorable oil removal even if a material, a shape or a size of an object to be treated is changed.

The present invention has an object to provide a superheated steam generation device which can be used for execution of the oil removal system and the oil removing method.

Moreover, the present invention has an object to provide an oil removal system and an oil removing method capable of performing not only favorable oil removal but also degreasing even if a material, a shape or a size of an object to be treated is changed.

### Means for Solving the Problems

The present invention is an invention completed by revising a mechanism of generation of dew condensation and a mechanism of removal of the dew condensation when oil is removed by using a dew condensation action of superheated steam.

The present invention provides an oil removal system. The system comprises a superheated steam generation device and an oil removal device, and the oil removal device provides an ejection portion to apply the superheated steam obtained by the superheated steam generation device to an object to be treated having oil on the surface. The object to be treated has its surface temperature lower than the superheated steam and is constituted to generate a dew condensation on the surface of the object to be treated by ejection of the superheated steam from the ejection portion and to remove the dew condensation from the surface of the object to be treated so as to remove the dew condensation and the oil on the surface of the object to be treated.

(Cooling Portion)

The oil removal device includes a cooling portion to lowers the temperature of the object to be treated and may be performed to apply the superheated steam to the object to be treated whose temperature was lowered.

(Removing Portion)

The oil removal device includes a removing portion to inject a removal fluid to the surface of the object to be treated after the superheated steam is applied and may be performed to remove the dew condensation and the oil from the surface of the object to be treated by injection of the removal fluid.

(Degreasing)

A degreasing device for further applying the superheated steam to the surface of the object to be treated from which the oil was removed by the oil removal device is provided, the degreasing may be carried out as being constituted such that the oil of the surface of the object to be treated is evaporated by heating the surface of the object to be treated equal to or more than evaporation temperature of the oil under a non-oxygen atmosphere due to the degreasing device

(Steam Generation Device)

Moreover, the present invention provides a superheated steam generation device which can be used in the oil removal system. This device is a superheated steam generation device in which include a steam generation portion to generate a steam by applying heat energy to a liquid water and a superheated steam generation portion to generate the superheated steam by further applying the heat energy to the steam obtained in the steam generation portion.

The steam generation portion includes a water tank capable of storing the water, a heating kettle for heating the water supplied from the water tank, and a heat source for heating water to apply the heat energy to the water in the heating kettle and the superheated steam generation portion includes a superheating furnace for storing the steam, and a heat source for heating steam to apply the heat energy to the steam in the superheating furnace. The heating kettle includes a steam ejection portion, and the steam ejection portion includes a main channel for sending the steam in the heating kettle to the superheated steam generation portion and a sub channel for sending the steam to the water tank, the heating kettle is constituted to preliminarily heat the water in the water tank by the steam from the sub channel.

(Planar Heating Element)

The heat sources of at least any one of the heat source for heating water and the heat source for heating steam may be included a planar heating element. The planar heating element includes at least any one of a metal foil and a metal lath, the metal foil includes a waveform structure portion in which a mountain part and a valley part are periodically repeated, and the wavy structure may be constituted by a metal foil having an incision part and a projection piece projecting from the incision part. Moreover, the metal lath may be constituted by a metal mesh body having a large number of through-holes arranged in a staggered arrangement in a plan view between a metal meshed line part.

(Oil Removing Method)

Moreover, the present invention provides an oil removing method by superheated steam, the method comprising steps of; a step of generating the superheated steam in the superheated steam generation device using the oil removal system, a step of applying the superheated steam from the ejection portion to an object to be treated having oil on the surface using the oil removal system, and by applying the superheated steam to the object to be treated having temperature lower than the temperature of the superheated steam, dew condensation is generated on the surface of the object to be treated whereby the oil on the surface of the object to be treated is removed together with the dew condensation.

The present invention can be carried out in such a manner that a step of lowering the temperature of the object to be treated prior to the step of applying the superheated steam from the ejection portion is included, the superheated steam is applied to the object to be treated whose temperature was lowered, and a step of injecting a removal fluid to the surface of the object to be treated after the step of applying the superheated steam from the ejection portion is included, the dew condensation and the oil are removed from the surface of the object to be treated by the injection of the removal fluid.

Furthermore, the superheated steam is further applied to the surface of the object to be treated from which the oil has been removed by the oil removal device to provide a step of heating the surface of the object to be treated equal to or more than evaporation temperature of the oil under a non-oxygen atmosphere, whereby the oil on the surface of the object to be treated is evaporated to perform degreasing.

### Effect of the Invention

The present invention can provide an oil removal system and an oil removing method capable of favorable oil removal even if a material, a shape or a size of an object to be treated is changed.

Moreover, the present invention can provide an oil removal system capable of performing not only favorable oil removal but also degreasing performed by evaporating the oil by high-temperature heating with the superheated steam and an oil removing method, even when a material, a shape or a size of an object to be treated is changed.

Moreover, the present invention can provide a superheated steam generation device which can be used for execution of the oil removal system which is capable of performing favorable oil removal and more preferably performing degreasing by evaporation of the oil and the oil removing method.

### BRIEF DESCRIPTION OF THE DRAWINGS

FIG. 1 is a configuration diagram of an oil removal system according to an embodiment of the present invention.

FIG. 2 is an explanatory diagram illustrating a main part of the oil removal system.

FIG. 3 is a structure explanatory diagram of a nozzle which can be used for the oil removal system.

FIG. 4(A) is a sectional view of a metal foil used as a planar heating element of the oil removal system, FIG. 4(B) is a sectional view of a laminated body comprised of the metal foil and a thin-film state metal lath used as the planar heating element of the oil removal system, and FIG. 4(C) is a sectional view of another metal foil used as the planar heating element of the oil removal system.

FIGS. 5(A) and 5(B) are cutaway perspective views of a main part of the metal foil, respectively, and FIGS. 5(C) and 5(D) are cutaway perspective views of a main part of the metal foil according to another embodiment, respectively.

FIG. 6(A) is a plan view of a variation of the metal foil, and FIG. 6(B) is a plan view of another variation of the metal foil.

FIG. 7 illustrates the metal foil used as the planar heating embodiment of the oil removal system, in which FIG. 7(A) is a plan view of the metal lath before treatment and FIG. 7(B) is a plan view of the thin-film state of metal lath.

FIG. 8 is an explanatory view of the metal lath according to the embodiment of the present invention.

FIG. 9 is a sectional view of the planar heating element using the thinned metal lath.

FIG. 10(A) is a perspective view for illustrating a structure of a coil structural body constituted by the laminated body, and FIG. 10(B) is a perspective view for illustrating a flow direction of a fluid to the coil structural body constituted by the laminated body.

### BEST MODE FOR CARRYING OUT THE INVENTION

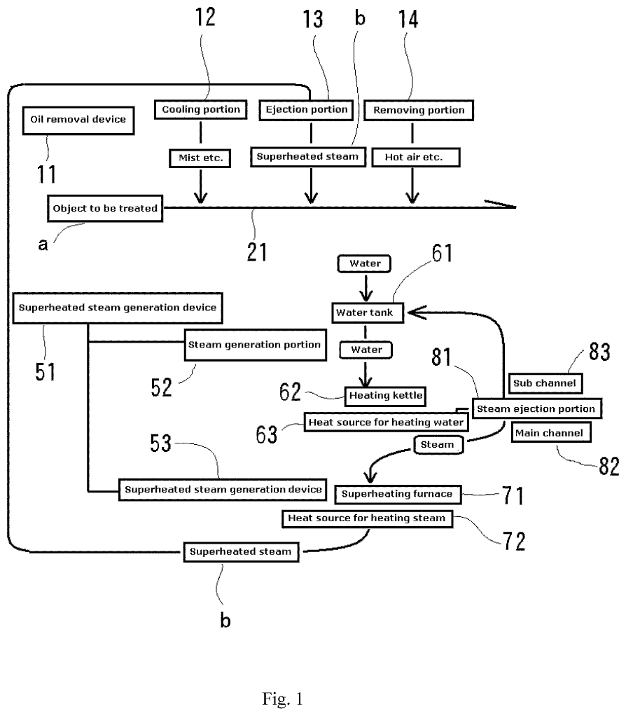

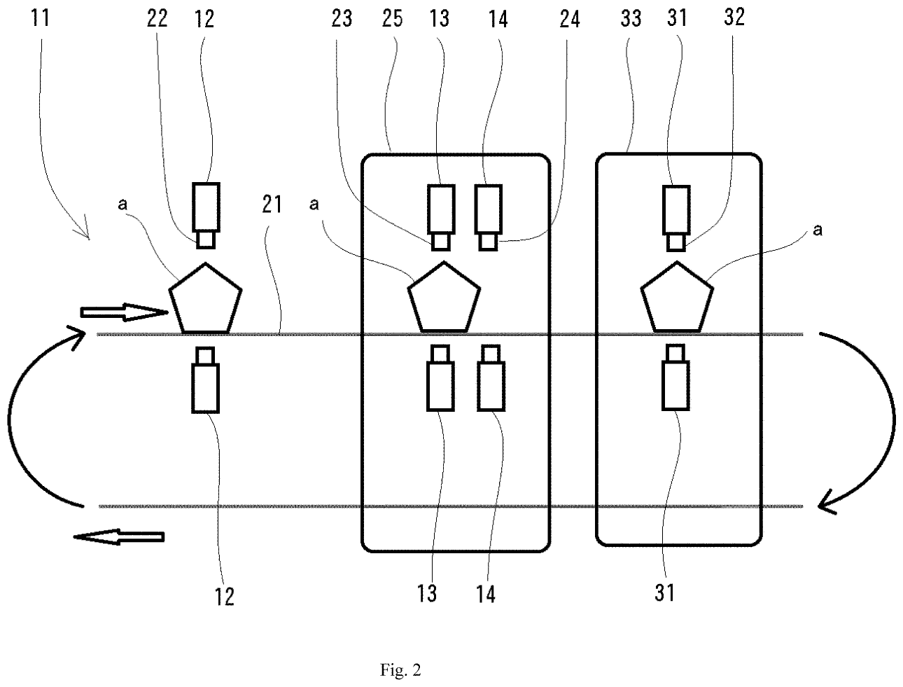

First, an oil removal system according to an embodiment of the present invention will be described on basis of FIGS. 1 to 3.

(Outline of Oil Removal System)

The oil removal system provides an oil removal device 11 to remove oil of an object to be treated a using a superheated steam b and a superheated steam generation device 51 to supply the superheated steam b to the oil removal device 11. The oil removal device 11 is used for removing the oil on the surface of the object to be treated a in a post-process of a processing equipment (not shown).

It is advantageous for production costs to arrange the processing equipment (not shown) and the oil removal device 11 on the same line as a so-called in-line system for continuous processing but they may be arranged in different lines.

(Processing Equipment and Object to be Treated)

A wide variety of the processing equipment (not shown) can be employed in accordance with a type of the object to be treated a. As illustrative example of the metal-made object to be treated a includes an independent member such as a mechanical component formed by press work, a long web-shaped continuous member such as a metal tape metal detergent and the like, a plate-like member and the like. Therefore, as the processing equipment (not shown), a rolling equipment, press equipment and the like can be exemplified. Moreover, the object to be treated a is not limited to metal-made, this system can be applied to other materials such as a made of synthetic resin or made of a composite material, various molding equipment can be employed as the object to be treated a. Further, when the in-line system is not employed, the processing equipment (not shown) is not indispensable, the oil removal device 11 can be also applied to the object to be treated a carried in from another place.

(Transfer Means)

The oil removal device 11 provides transfer means 21 to movie the object to be treated a from upstream to downstream. The form of the transfer means 21 can be changed depending on the type of the object to be treated a, and for example, when the object to be treated a is an independent component or member, a belt conveyer, a net conveyer or a roller conveyer can be employed, and the object to be treated a may be transferred in suspended state by a hanger or the like. When the object to be treated a is a continuous member, the device may be provided with a feed roller or a driven support roller.

(Cooling Portion)

A cooling portion 12 is used for lowering a surface temperature of the object to be treated a and is arranged on the upstream side of the transfer means 21. As the cooling portion 12, various cooling devices can be employed, and for example, illustrative embodiment can be shown that low temperature water is sprayed from a cooling nozzle 22 to the object to be treated a to reduce the surface temperature by using evaporation heat.

(Ejection Portion)

The ejection portion 13 provides an injection nozzle 23 to inject the superheated steam b supplied from the superheated steam generation device 51 to the object to be treated a transferred by the transfer means 21. Temperature difference Δt (tb−ta=Δt) between a temperature tb of the superheated steam b injected from the injection nozzle 23 and a surface temperature ta of the object to be treated a having passed through the cooling portion 12 is preferably 110° C. or more. The larger the temperature difference Δt is preferable, however, from a viewpoint of energy efficiency, about 310° C. or less is appropriate. Due to the temperature difference Δt, dew condensation can be reliably generated on the surface of the object to be treated a by the injection of the superheated steam b.

The temperature difference Δt can be increased by increasing the temperature of the superheated steam b, but higher the temperature of the superheated steam b, the more energy is required, thus, it is disadvantageous from the viewpoint of energy saving. On the other hand, in many cases, the object to be treated a that has been processed by the processing equipment (not shown) has the surface temperature ta of 60 degrees Celsius or higher. Assuming the case of in-line processing, when the distance between the processing equipment (not shown) and the oil removal device 11 is increased, the surface temperature ta of the object to be treated a is decreased due to natural cooling, when the transfer speed by the transfer means 21 is decreased, the transfer time becomes longer and the natural cooling can take place, however, increase of plant facility and the production time cannot be avoided.

Accordingly, by setting the temperature tb of the superheated steam b in the injection nozzle 23 in the range of 170 to 370° C. and the surface temperature ta of the object to be treated a having gone through the cooling nozzle 22 at 60° or less, the temperature difference Δt can be made 110° or more. As a result, the dew condensation can be reliably generated on the surface of the object to be treated a, and the subsequent action can be performed.

That is, a temperature energy of the superheated steam instantaneously heats the oil on the surface of the object to be treated a thereby floating from the surface of the object to be treated a. By contacting the moisture in the superheated steam with the object to be treated a having the temperature difference Δt, the moisture instantaneously becomes liquid water and enters between the surface of the object to be treated a and the oil. As more gas moisture of the superheated steam is cooled, more liquid water is generated. By doing above, the floated oil is washed out.

By providing a casing 25 including the object to be treated a and the injection nozzle 23, the ejection portion 13 can maintain a temperature in the casing 25 constant, and stably maintain the temperature difference Δt. Needless to say, it is appropriate to arrange the cooling nozzle 22 of the cooling portion 12 outside the casing 25.

(Removing Portion)

A removing portion 14 provides a blowing nozzle 24 for injecting a removal fluid such as an air at a normal temperature or a hot air to the object to be treated a. By the removal fluid from the blowing nozzle 24, the oil floated from the surface of the object to be treated a is blown off together with the liquid water, thus can be forcibly removed from the surface of the object to be treated a. As a result, even if there is a dent on the surface of the object to be treated a or not enough amount of the liquid water to wash out is generated, the oil can be reliably removed from the surface of the object to be treated a. Therefore, it is appropriate to provide the injection nozzle 23 and the blowing nozzle 24 in closer positions to each other, but it may be possible to provide them at positions far from each other for execution.

By providing the removing portion 14 in this manner, the execution can be made under the condition that the generation amount of dew condensation due to the application of the superheated steam b by the ejection portion 13 is small, as a result, the amount of the necessary energy as the entire system is reduced, and further the reliable oil removal can be realized. Meanwhile, it is appropriate that the removing portion 14 is arranged inside the aforementioned casing 25 for execution, but it may be arranged outside the casing 25 for the execution.

(Degreasing Device and Degreasing Method)

In execution of the present invention, the degreasing device 31 can be arranged on the downstream side of the oil removal device 11. The degreasing device 31 is a device to further apply the superheated steam b to the surface of the object to be treated a from which the oil has been removed by the oil removal device 11. The degreasing device 31 provides an injection nozzle 32 to eject the superheated steam b and also provides a furnace 33 to maintain the entire atmosphere being high temperature. By the furnace 33, the inside thereof is filled with the superheated steam b, and the surface of the object to be treated a is heated to a temperature above the evaporation temperature of the oil under the non-oxygen atmosphere, whereby the oil on the surface of the object to be treated a is evaporated and degreased. By making the furnace 33 an independent furnace separate from the casing of the aforementioned oil removal device 11, not only maintaining high temperature in a small volume space is readily, but also it can be a space continuous to the casing 25. Regarding the superheated steam b supplied to the furnace 33, it is possible to supply from the superheated steam generation device 51 that is identical to the superheated steam b supplied to the oil removal device 11.

(Superheated Steam Generation Device)

The superheated steam generation device 51 provides a steam generation portion 52 and a superheated steam generation portion 53.

The steam generation portion 52 provides a water tank 61 to receive water at a normal temperature such as tap water and a heating kettle 62 such as a boiler into which the water from the water tank 61 is poured. In the heating kettle 62, a heat source for heating water 63 is arranged, the liquid water is heated by heat source for heating water 63 to generate the gas steam. The steam thus generated is ejected from a steam ejection portion 81 to an outside of the heating kettle 62. The steam ejection portion 81 is divided into a main channel 82 and a sub channel 83, and the main channel 82 is connected to a superheating furnace 71 of the superheated steam generation portion 53. In the superheating furnace 71, A heat source for heating steam 72 to further heat the steam is arranged. By the heating of the heat source for heating steam 72, the steam in the superheating furnace 71 becomes the superheated steam b, the obtained superheated steam b is distributed and supplied to the injection nozzles 23 and 32 of the ejection portion 13 and the degreasing device 31 via a supply path 73. As a matter of course, in the first embodiment which does not provide the degreasing device 31, only to the injection nozzle 23 is supplied.

The water tank 61 may be simply a tank for temporarily storing water but can be also constituted to work as a water-level adjustment tank. When it is executed as the water-level adjustment tank, a level sensor (not shown) is arranged inside the water tank 61, by which a water amount in the water tank 61 is kept within a certain range, depending on the amount of the water to be consumed in the water tank 61, it can be constituted such that the water is stably supplied from the water tank 61 to the heating kettle 62.

The sub channel 83 is connected to an upper space of the water tank 61. By this, a part of the steam from the steam ejection portion 81 applies a pressure to the water inside the water tank 61 and gives an residual heat. As a result, since the water inside the water tank 61 is supplied to the heating kettle 62 in a state of being heated and pressurized in advance, the energy efficiency can be improved.

(Heat Source for Heating Water and Heat Source for Heating Steam)

The heat source for heating water 63 and the heat source for heating steam 72 are not limited the types as long as they apply heat energy to the water or the steam, for example, various gases and liquid of fossil fuel energy and electric energy can be used.

When using the electric energy, various electric heaters may be used, but it is preferable to carry out by using a planar heating element which will be described later.

(Injection Nozzle)

As for the injection nozzles 23 and 32, various prior well-known nozzles can be used, however, when the nozzle providing the planar heating element described later is used for the execution, superheated steam b being stable at the high temperature can be applied to the object to be treated a.

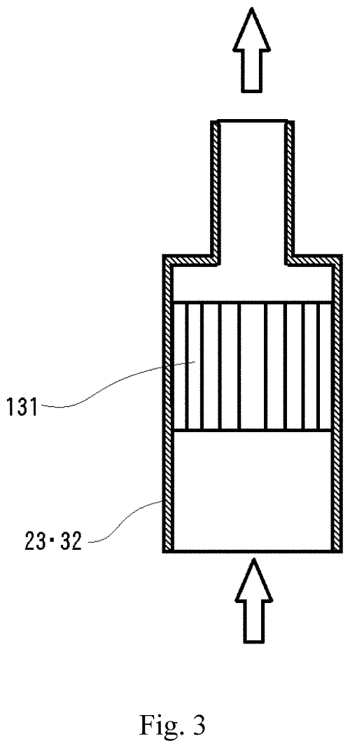

FIG. 3 shows a specific form thereof, a coil structural body 131 being wound the metallic planar heating body is arranged in the fluid paths of the nozzles 23 and 32. Thus, while passing through inside the coil structural body 131 in an axial direction thereof, the steam or the superheated steam is further heated to high temperature, and the obtained stable superheated steam can be applied to the object to be treated a.

(Planar Heating Element)

As for the planar heating element of the heat source for heating water 63 and the heat source for heating steam 72 and the injection nozzles 23 and 32, a metal foil 110 and a thin-film state metal lath 120 having a waveform structure can be suitably used.

The metal foil 110 provided with waveform structure portion in which mountain part and valley part are periodically repeated and the waveform structure thereof is constituted by metal foil having an incision part and a projection piece projecting from the incision part can be suitable used, and the thin-film state metal lath 120 constituted by metal mesh body having a large number of through-holes arranged in a staggered arrangement in a plan view between a metal meshed line part, and the upper and lower surfaces thereof are plane can be suitably used. The metal foil 110 and the thin-film state metal lath 120 may be used singularly or may be used as a laminated body in which the both are overlapped together. Moreover, another sheet-like insulator may be arranged therebetween the metal foil 110 and the thin-film state metal lath 120, and insulation process is carried out either one of the metal foil 110 and the thin-film state metal lath 120, and of them, the other may be used as a heating element. These various planar heating elements may have a flat plate shape, also may constitute a coil structural body wound in a spiral state.

(Outline of Planar Heating Element by Metal Foil)

The metal foil 110 is provided with waveform structure portion in which mountain part and valley part are periodically repeated and the waveform structure thereof is included metal foil having an incision part and a projection piece projecting from the incision part. In one incision part mentioned above, a plurality of the projection piece is separated from each other and protrudes inward to the inside of the waveform structure portion. The mountain part and the valley part may have a trapezoidal shape in which a surface of mountain top or a surface of valley bottom is substantially flat, the incision part may be formed at a position where the surface of mountain top or the surface of valley bottom is included, and the projection piece may not project upward from the surface of mountain top or downward form the surface of the valley bottom.

(Specific Structure of Metal Foil)

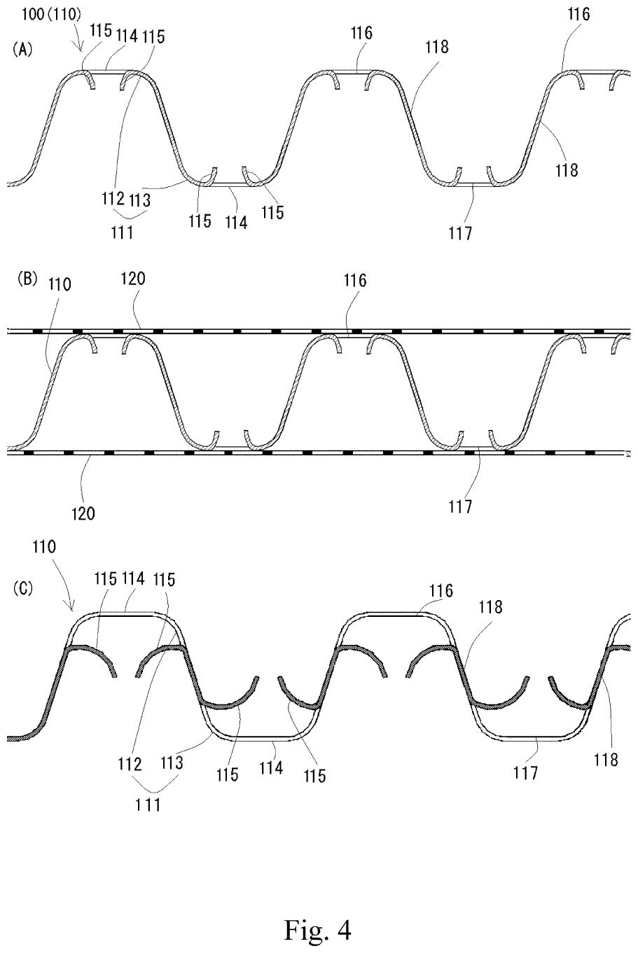

Hereafter, a specific embodiment of the metal foil 110 will be explained according to FIGS. 4 to 6. The explanations below are made on the basis of the web-shaped metal foil 110, but it can be executed in various forms such as a single plate which is cut into an appropriate length.

In the case of the web-shaped metal foil 110, as shown in FIG. 4(A), the mountain part 112 and the valley part 113 are arrayed alternately in a longitudinal direction thereof (left-and-right direction in the figure), and the extending direction of the mountain part 112 and the valley part 113 are in a width direction of the web. Hereinafter, the longitudinal direction will be described as a vertical direction or a front-and-rear direction, and the width direction will be described as a lateral direction or the right-and-left direction, however, these descriptions merely indicate the relative positional relationship and do not specify absolute positions. Moreover, the longitudinal direction of the web and the extending direction of the mountain part 112 and the valley part 113 should not be understood in a fixed manner, the extending direction of the mountain part 112 and the valley part 113 may be executed as the width direction of the web, or may be executed as which is inclined to the width direction and the longitudinal direction of the web.

The material of the metal foil 110 may be formed of various materials such as metal and synthetic resins, in particular, in the case of imparting a self-heating property or the like, metal having conductivity such as iron or its alloy (for example, a Fe—Cr—Al alloy with high specific resistance) is preferable. The plate thickness used for execution is preferably a thin plate (foil) with about in the range of 0.02 to 0.1 mm such as 0.05 mm, but it can be changed in accordance with an application.

This metal foil 110 includes a waveform structure portion 111 in which the mountain part 112 and the valley part 113 are alternately arrayed. The waveform structure portion 111 can be executed as being formed on the entire metal foil 110, but may be executed as being formed only in part of the metal foil 110. When the waveform structure portion 111 is formed only in part thereof, for example, it may be arranged on a center part of the metal foil 110, a half part in the width direction, or a peripheral part or the like.

The mountain part 112 and the valley part 113 may be executed as symmetric in the vertical direction, but the mountain part 112 and the valley part 113 may have different widths and heights.

In this embodiment, the mountain part 112 and the valley part 113 are provided with a flat surface of mountain top 116 and a flat surface of valley bottom 117, and between the surface of mountain top 116 and the surface of valley bottom 117 form a substantially trapezoidal cross-section shape which is connected by an inclined surface 118. A corner part among the surface of mountain top 116, the surface of valley bottom 117 and the inclined surface 118 may be formed with roundness, the trapezoidal shape should not be understood as being limited to a geometric meaning. Since the surface of mountain top 116 and the surface of valley bottom 117 are flat, effect can be exhibited such that a contact area with another sheet-like bodies to be laminated such as the thin-film state metal lath 120 can be increased or the like.

(Incision Part and Projection Piece)

The metal foil 110 is provided with a incision part 114 and a projection piece 115 in waveform structure portion 111 thereof.

The incision part 114 and the projection piece 115 may be formed by appropriate means, for example, may be formed by burring process on the metal foil 110.

Specifically, it can be executed as a burr formed by the burring process, a plurality of the projection piece 115 can be formed to the one incision part 114. The projection pieces 115 project separated from each other and at least the tips thereof are independent from each other (note that, the projection pieces 115 may be connected at their basis each other, but the tips of them are independent as being independent from each other), a flowing space 119 exists between the projection pieces 115, a fluid represented by a gas such as air can flow in a thickness direction (inside-and-outside direction) of the metal foil 110 from the flowing space 119 between the projection pieces 115.

Each of the projection pieces 115 project toward the inside of the waveform structure portion 111. Since the waveform structure portion 111 has a plate-like shape as entirety, the meaning of inside/outside is merely relative, but it can be executed in a manner such that the waveform structure portion 111 is divided in two by a virtual line between the mountain part 112 side and the valley part 113 side, the projection piece 115 in the mountain part 112 side is projected into a space defined by the virtual line and the mountain part 112, and the projection piece 115 in the valley part 113 side is projected into a space defined by the virtual line and the valley part 113. In other words, the projection piece 115 are not projected upward from the surface of mountain top 116 and downward to the surface of valley bottom 117. By this, due to a synergic effect of the aforementioned substantially flat surface of mountain top 116 and the surface of valley bottom 117, as illustrated in FIG. 4(B), the contact area with the thin-film state metal lath 120 can be increased, and defective brazing can be suppressed. Moreover, the effect of not damaging the material of the other member in contact can also be exhibited.

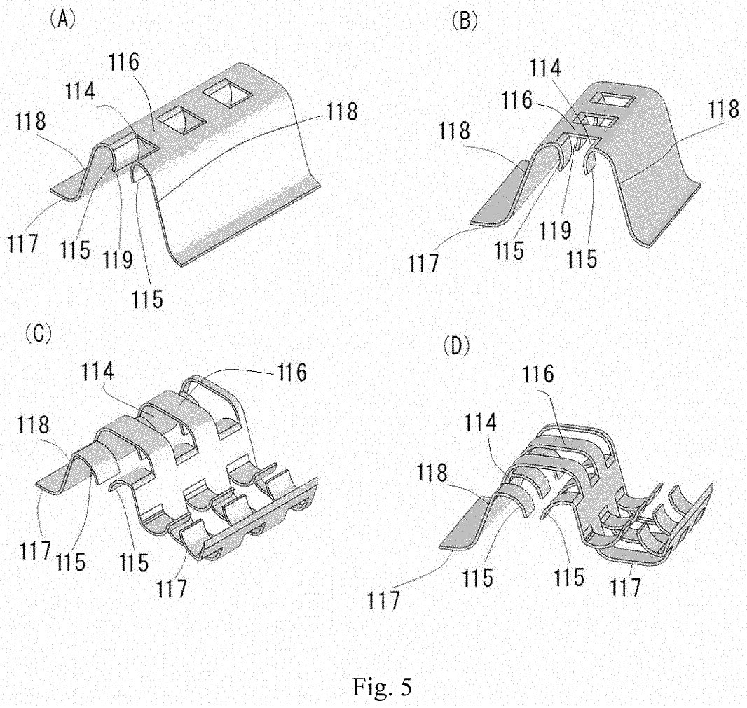

With regard to the formation positions of the incision part 114 and the projection piece 115, as illustrated in FIGS. 4(A), 5(A) and 5(B), the incision part 114 and the projection piece 115 may be only formed on the surface of mountain top 116 or the surface of valley bottom 117 and not on the inclined surface 118, further as illustrated in FIGS. 4(C), 5(A) and 5(B), the incision part 114 and the projection piece 115 may be formed continuously to the surface of mountain top 116 or the surface of valley bottom 117 and the inclined surface 118.

The projection piece 115 can be changed in various ways according to the structure of mold and the like, the projection piece 115 may be executed as twelve projection pieces 115 projecting from twelve positions before and after the incision part 114 or may be executed as the projection pieces 115 projecting from 3 positions or mote of the incision part 114. Moreover, the shape of the incision part 114 on the plan view may be rectangular, circular or oval.

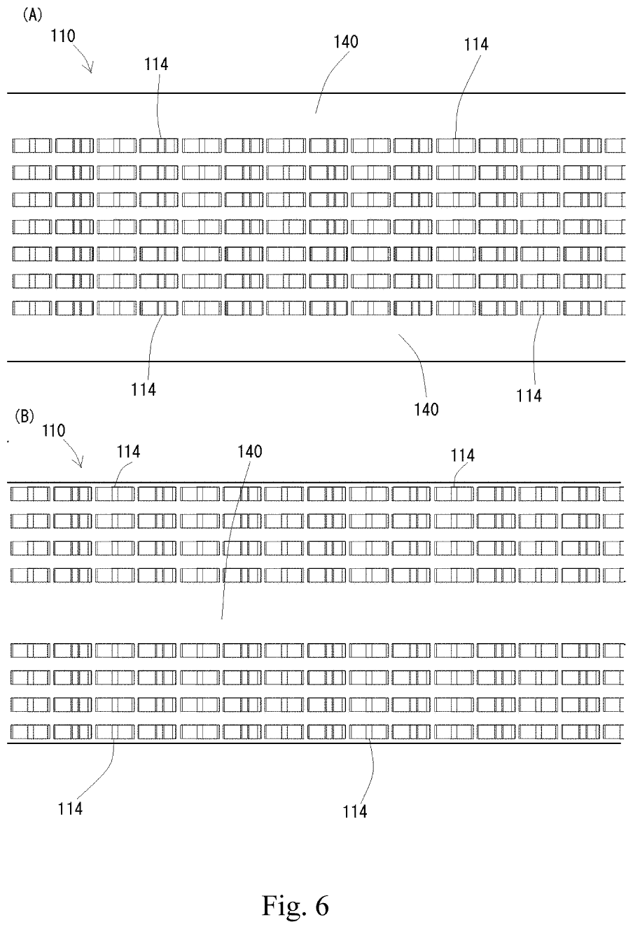

The projection piece 115 can be also formed by a method other than burring, for example, and can be formed by cutting out the incision part 114 with a blade bending an excess portion. Moreover, the positions where the incision parts 114 are provided may be uniformly provided on the entire metal foil 110, or may be ununiformly provided, or may be partially provided. For example, various modification can be made such that as shown in FIG. 6(A), a region 140 where the incision 114 is not formed can be provided on the both sides in the width direction of the web-like metal foil 110, or as shown in FIG. 6(B), a region 140 where the incision part 114 is not formed can be provided on the center in the width direction of the web-like metal foil 110.

An electrode or the like (not shown) is provided at an appropriate position such as an edge portion of this metal foil to make it possible to conduct electricity, whereby main structure of the planar heating element 100 is completed. It is preferable that metal foil 110 maintain the favorable flow of the fluid in the periphery thereof (the thickness direction of the metal foil 110 and the longitudinal direction of the waveform structure portion 111) while a contact area to a target object to be laminated be increased in the case of laminated use, and a structure of the aforementioned metal foil 110 present a structure suitable for this. Particularly, since the projection piece 115 is projected the inside of the mountain part 112 or the valley part 113, in a space regulated by the surface of mountain top 116 or the surface of valley bottom 117 and the inclined surface 118, the generation of disturbance of the fluid by presence of the projection piece 115 and the surface of mountain top 116 can be promoted, and since the forms of the incision part 114 and the projection piece 115 can appropriately maintain the flow of the fluid to both the thickness direction of the metal foil 110 and the longitudinal direction of the waveform structure portion 111, a favorable flow of the fluid, contact time with the fluid, and increase of the contact area can be realized.

(Outline of Planar Heating Element by Metal Lath)

Subsequently, the planar heating element by the metal lath will be described. The planar heating body can be executed as the metal lath provided with a large number of through-holes arranged in a staggered arrangement in a plan view between a metal meshed line part having conductivity, it is preferable that the thickness of the metal meshed line part be 0.1 mm or less and an electric resistance value having a width 10 mm×a length 1000 mm as a measurement unit be 50 or more.

The metal lath may be formed by processing the metal lath having a large number of through-holes arranged in a staggered arrangement in a plan view between a metal meshed line part. At that time, by changing a pitch width of a strand of the meshed line part and a size of the through-hole and applying a force to the metal lath in the thickness direction to change the thickness of the meshed line part, a thin metal lath whose electric resistance value is controlled is obtained, thus, the planar heating element can be obtained by the thin metal lath.

More specifically, the thickness of the meshed line part of the metal lath before applying the force in the thickness direction is 0.3 mm or more, and the thickness of the meshed line part is changed so as to be 0.1 mm or less by subjecting the metal lath to the rolling process, thus, the thin metal lath having the electric resistance value with the width 10 mm×the length 1000 mm as a measurement unit controlled to 5Q or more can be obtained.

(With Respect to Specific Form of Planar Heating Element by Thin-Film State Metal Lath)

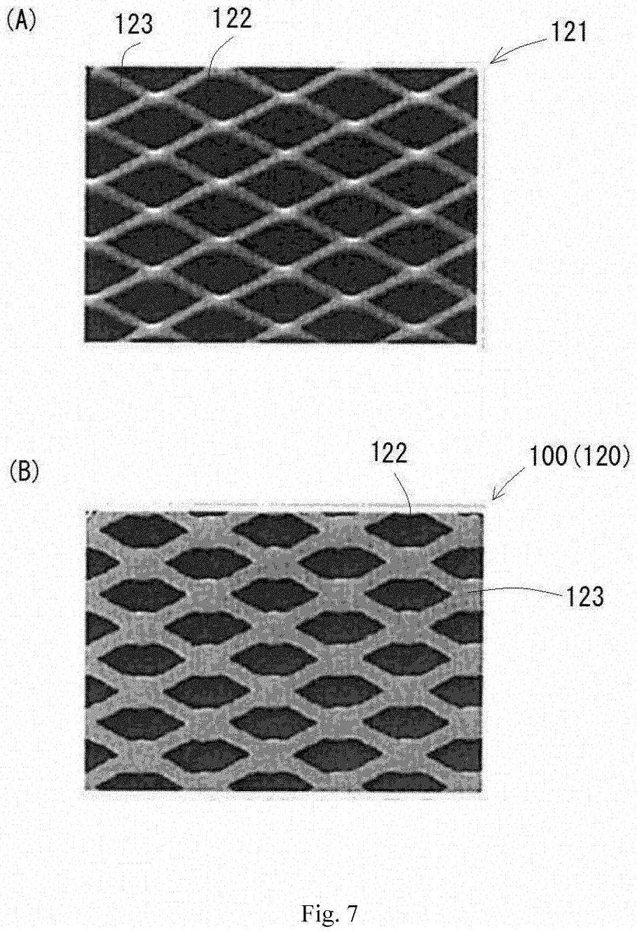

Hereinafter, a specific embodiment of the planar heating element 100 by the thin metal lath 120 will be described according to FIGS. 7 to 9.

The heating portion of the planar heating element 100 is constituted by the thin-film state metal lath 120. The thin film state metal lath 120 provides, as illustrated in FIG. 7(B), a large number of the through-holes 122 arranged in the staggered array, and is manufactured by forming a slit on a metal plate and performing a lath process to subject an expanding process or the like, and includes a large number of through-holes 122 having the identical shape. The shape of the through-hole 122 is generally rhombus or the like, it may be rectangular such as a rectangle, and may be appropriately changed. A portion not removed by the through-hole 122 constitutes a meshed line part 123.

The thin-film state metal lath 120 is produced by adjusting the pitch width of the strand of the meshed line part and the size of the through-hole to the metal lath 121 subjected lath process before treatment (see FIG. 7(A)), and by changing the thickness of the meshed line part 123 due to the application of the force in the thickness direction by the rolling process to control the electric resistance (see FIG. 7(B)). Hereinafter, in the embodiment of the present invention, in the case of only subjecting the thinning process to the metal lath, it refers as the thin-film state metal lath 120, in the case of not subjecting the thinning process to the metal lath, it refers as the metal lath 121 before processing

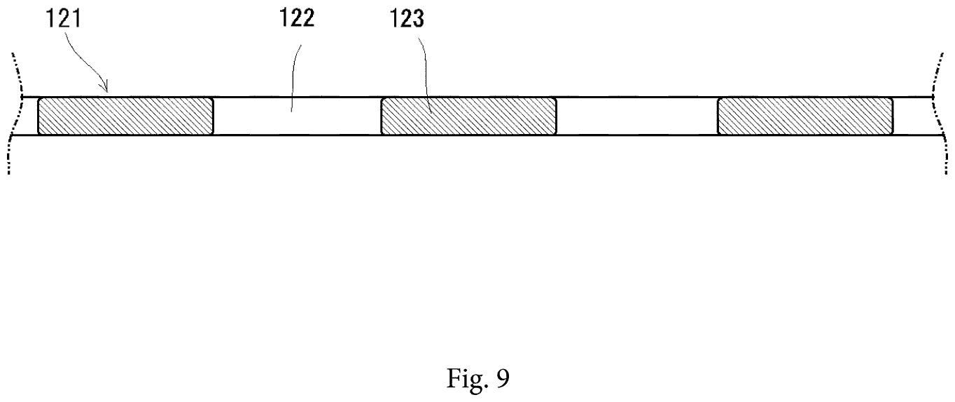

The thin-film state metal lath 120 is in the form of thin plate state in which the meshed line part 123 is substantially flat, and the upper and lower surfaces thereof are substantially planar as shown in FIG. 9.

An electrode or the like (not shown) is provided at an appropriate position such as the end portion of the thin-film state metal lath 120 to conduct electricity, whereby a main structure of the planar heating element 100 is completed.

(Raw Material of Sheet Metal)

The thin-film state metal lath 120 can be produced by using a sheet metal having the plate thickness of about 0.03 to 0.1 mm as its material, and it can be changed for the execution depending on the usage of the planar heating element 100 or desired heating performances and the like. The material of the thin-film state metal lath 120 can be formed by a material having conductivity, in particular, it is appropriate to execute by using a metal having high electric resistance such as iron and its alloys (for example, Fe—Cr—Al alloy having high specific resistance) in order to give heating performances.

(Metal Lath Before Processing)

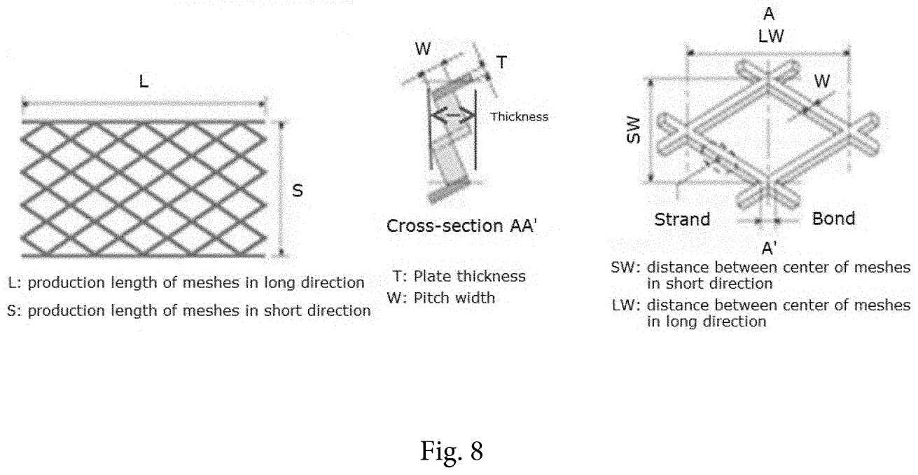

The metal lath 121 before processing is also referred to as an expanded metal, for example, it is a mesh-like plate in which the material of the sheet metal is pushed out (expanded) while making cuts in staggered state by a mold of expanded metal producing machine, and the cuts are in the form of a rhombus or a hexagonal pattern, in this embodiment, an opening of the mesh is referred as the through-hole 122, and the metal part is referred as the meshed line part 123. In this meshed line part 123, the line-state part is referred as a strand 124, and apart where the strands 124 cross each other is referred as a bond 125. Meanwhile, the distance between center of meshes in a short direction is referred as SW, the distance between the center of the meshes in a long direction is referred as LW, and a pitch width of the strands is referred as W (see FIGS. 7(A) and 8). The size of the mesh and the thickness of the lath can be appropriately changed for the execution, in particular, it can be executed within the following range.

SW: 1.0 to 3.0 mm

LW: 1.5 to 6.0 mm

W: 0.3 to 0.8 mm

Thickness of lath: 0.3 to 1.0 mm However, as illustrated in FIG. 8, the SW is the distance between the center of the meshes in the short direction, the LW is the distance between the center of the meshes in the long direction, and the thickness of the lath (in FIG. 8, indicated only as a thickness) is the distance from a lower end to an upper end in the thickness direction of the metal lath. Since the metal lath 121 before processing not only forms slits on the material of the sheet metal, but also expanding process is subjected, in the cross section thereof, the meshed line part 123 is inclined, as shown in FIG. 8, the upper and lower surfaces (in the drawing, right and left surfaces) are constituted by angles of the meshed line parts 123. Therefore, in principle, the contact with another part is not planar contact but linear contact.

(Rolling Process)

The thin-film state metal lath 120 can be obtained by applying the force in the thickness direction such as subjecting the rolling process or the like to the metal lath 121 before processing to change the thickness and the width of the meshed line part 123. As shown in a change from FIG. 7(A) to FIG. 7(B), the thickness of the meshed line part 123 is decreased and the width on the plan view is increased due to the application of rolling process. The thin-film state metal lath 120 thus obtained becomes a thin plate state in which the meshed line part 123 is a substantially flat, and the upper and lower surfaces become substantially planar as shown in FIG. 9, and in principle, contact with another part is planar contact.

The planar heating element 100 by the thin-film state metal lath 120 can change its heating performances and performances as a heater by changing the electric resistance value and the surface area. In particular, in comparison with material of the sheet metal, the electric resistance value can be increased by four times or more (preferably ten times or more). Specifically, the electric resistance value with the measurement unit of the width 10 mm×the length 1000 mm was approximately 1Ω to 2Ω in the sheet metal (iron-chrome-aluminum alloy) but thin-film state metal lath 120 can increase approximately 5Ω or more or preferably approximately 10Ω to 60Ω, which was a great surprise for the inventor. In particular, it is considered that those indicating approximately 20Ω to 40Ω are preferable in view of a balance between the heating performances and strength.

The size of the mesh in the thin-film state metal lath 120 can be appropriately changed for the execution, in particular, it can be executed within the following range.

SW: 1.0 to 3.0 mm

LW: 1.5 to 6.0 mm

W: 0.3 to 0.8 mm

Thickness of lath: 0.03 to 0.1 mm or less (particularly preferably 0.03 to 0.07 mm)

In the planar heating element 100 using the thin-film state metal lath 120, the electric resistance value is drastically increased, and the electric resistance value can be changed depending on the mesh shape of lath processing and a degree of rolling (thickness after rolling). Moreover, in the planar heating element 100 using the thin-film state metal lath 120, amount of power consumption required to obtain the same heating temperature (surface temperature of the metal) can be reduced as compared with the sheet metal and the metal lath 121 before processing, and with the same amount of power consumption, a larger temperature increase can be obtained.

(Application Example as Laminated Body)

The metal foil 110 and the thin-film state metal lath 120 may be used alone, respectively, but can be executed as a laminated body 130 in which the both are combined.

The metal foil 110 and the thin-film state metal lath 120 may be used in a state not bonded to each other (including both in a state where the they are in contact and not in contact) and may be also used in a state where the metal foil 110 and the thin-film state metal lath 120 are bonded, and a structural body in which these states are combined and the metal foil 110 and the thin-film state metal lath 120 are laminated in the thickness direction is called the laminated body 130.

(Form in which Metal Foil and Metal Lath are not Bonded)

As will be described later, the metal foil 110 and the thin-film state metal lath 120 may be executed in a form being bonded together but may be also executed in a form not being bonded. As the form in which they are not bonded, it is preferable that a state where the metal foil 110 and the thin-film state metal lath 120 be in contact (especially planar contact when the substantially flat surface of mountain top 116 or the surface of valley bottom 117 are included), but it may be a state where a space exist between them without contacting each other (including the planar contact). However, when executing in the state which is in contact, the aforementioned projection piece 115 can effectively exhibit the effect which the projection piece 115 projects inward.

(Form in which Metal Foil and Planar Heating Element are Bonded)

The form in which the metal foil 110 and the thin-film state metal lath 120 are bonded is to integrate them by bonding means, and one non-separable sheet structural body is constituted. The bonding means may be any one as long as they are integrated, but preferable illustrative example can be shown such as brazing and welding. When those bonding means is to be executed, the metal foil 110 and the thin-film state metal lath 120 need to be metals capable of brazing or welding, and in that case, as aforementioned,

since the projection piece 115 is projected toward the inside of the waveform structure portion 111 and the surface of mountain top 116 and the surface of valley bottom 117 are substantially flat, the metal foil 110 and the thin-film state metal lath 120 can be brought into planar contact, and defects in brazing or welding can be suppressed. As other bonding means, the illustrative example can be shown bonding by a fastening body such as a screw or a rivet, adhesion by an adhesive and the like, fixing by various tapes, and various bonding means can be used in combination.

When the metal foil 110 and the thin-film state metal lath 120 are bonded, the brazing or the like may be performed to form only on a part thereof. At that time, as shown in FIG. 6(A), when the both side edges of the web-shaped metal foil 110 in the width direction are brazed to the thin-film state metal lath 120, a brazing area can be further increased by brazing on the region 140 in which the incision part 114 is not formed. The region 140 in which the incision part 114 is not formed can be executed with various changes such as providing at the center in the width direction of the web-shaped metal foil 110 (see FIG. 6(B)).

As will be described later, when the metal foil 110 and the thin-film state metal lath 120 are laminated and wound in a coil form, they may be wound in the state where the both are bonded in advance, but may be wound in the state not bonded in advance by considering the difference in a circumference ratio between them, and a brazing agent may be arranged on the end of the surface being coiled after completion of the winding to perform brazing. Moreover, when the both are bonded after the completion of the winding, it can be so constituted that the both are bonded only on ends of the winding and bonded only to an inner circumference thereof.

When the metal foil 110 and the thin-film state metal lath 120 are bonded, it can be executed by forming brazing and the like only on the part thereof. At that time, when brazing is performed on the both side edges in the width direction of the web-shaped metal foil 110 to the thin-film state metal lath 120, the brazing area can be further increased not by forming the incision part 114 or the projection piece 115 on the brazing part. The region where the incision part 114 or the projection piece 115 are not formed can be executed with various changes such as providing at the center in the width direction of the web-shaped metal foil 110 and the like.

(Working Effect of Laminated Body)

Regardless of the presence of the aforementioned bonding, the laminated body 130 can prohibit a synergic effect with the thin-film state metal lath 120 in addition to the merit as the aforementioned metal foil 110 single body.

In a relationship between the laminated body 130 and the fluid in the periphery thereof, the space is further limited by the presence of the thin-film state metal lath 120 in addition to the surface of mountain top 116 or the surface of valley bottom 117 and the inclined surface 118. In this case, when the thin-film state metal lath 120 is executed as not allowing or limiting the passage of the fluid, movement of the fluid between each of the laminated bodies 130 can be limited. On the other hand, when the through-hole 122 is provided or the like, the movement of the fluid between each of the laminated bodies 130 can be allowed. In this case, the movement of the fluid between each of the laminated bodies 130 can be sufficiently ensured by presence of a flowing space 119 between the projection pieces 115 and the incision part 114. In particular, it is preferable to provide the through-hole 122 when the movement of the fluid between each of the laminated bodies 130 is required or when it is advantageous that there is the movement of the fluid between each of the laminated bodies 130.

(Coil Structural Body)

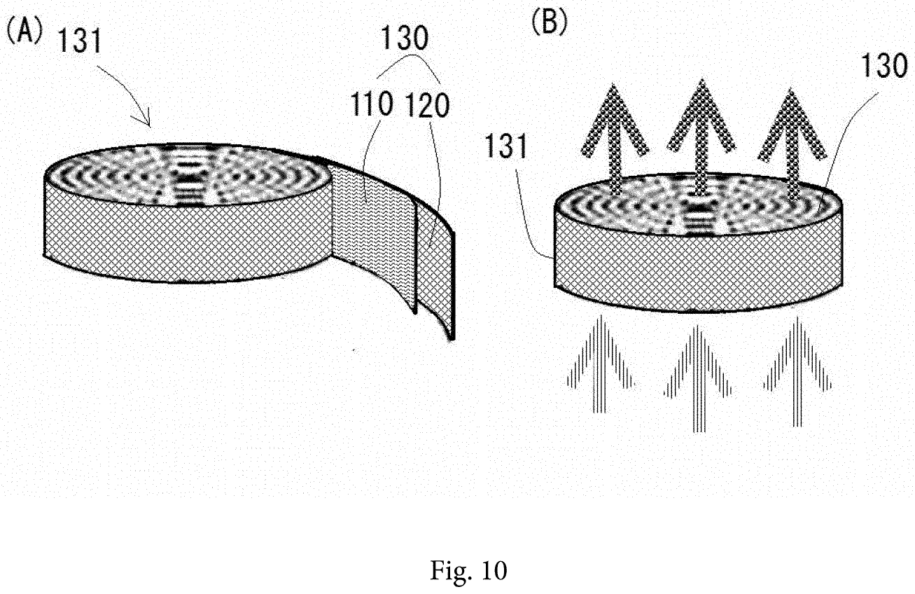

The laminated body 130 may be used as a flat-plate shaped sheet structural body, but as shown in FIG. 10, it may be also executed as the coil structural body 131 wound in a spiral state. Of the metal foil 110 and the thin-film state metal lath 120, any one of them can be made a heating element which generate heat by energization, while the other can be made an insulating body which is subjected the insulating process to the surface thereof. In either case, since both the metal foil 110 and the thin-film state metal lath 120 have through portions in the thickness direction, the fluid can also flow over the plurality of layers in the radial direction of the coil structural body 131, and three-dimensional movement of the fluid is promoted.

Meanwhile, the metal foil 110 and the thin-film state metal lath 120 may not be bonded, nor may be bonded. Since the surface of mountain top 116 and the surface of valley bottom 117 of the metal foil 110 are substantially flat and the projection piece 115 is projected to the inside, the thin-film state metal lath 120 is not damaged, and in the case of bonding, defects in brazing or welding can be suppressed. Therefore, when the thin-film state metal lath 120 is made the insulating body to which the insulating process is subjected to the surface thereof, the generation of electric short-circuit caused by projection piece 115 damaging the insulating process can be suppressed.

A winding direction may be so as to be one end side in the longitudinal direction of the web being an inner circumferential end and the other end side being an outer circumferential end, in other words, in the extending direction of the mountain part 112 and the valley part 113, the width direction of the web may be wound so as to be substantially fit in the axial direction of the coil structural body 131. As a result, the fluid can flow from one end surface to the other end surface in the axial direction of the coil structural body 131 (from the lower surface to the upper surface in FIG. 10(B)), and the flowed fluid can be moved to the circumferential direction of the laminated body 130 during movement from the one end surface to the other end surface, thus it can promote turbulence of the fluid.

This coil structural body 131 may be arranged in a hollow cylindrical shape limited channel as shown in FIG. 3. In this embodiment, by allowing the steam to pass from the one end surfaces of the coil structural body 131 to the other end surface, the steam can be directly superheated, size reduction can be achieved, and improvement of heating efficiency can be also achieved.

### EXPLANATION OF REFERENCE NUMBER

11 oil removal device
12 cooling portion
13 ejection portion
14 removing portion
21 transfer means
22 cooling nozzle
23 injection nozzle
24 blowing nozzle
25 casing
31 degreasing device
32 injection nozzle
33 furnace
51 superheated steam generation device
52 steam generation portion
53 superheated steam generation portion
61 water tank
62 heating kettle
63 heat source for heating water
71 superheating furnace
72 heat source for heating steam
73 supply path
81 steam ejection portion
82 main channel
83 sub channel
100 planar heating element
110 metal foil
111 waveform structure portion
112 mountain part
113 valley part
114 incision part
115 projection piece
116 surface of mountain top
117 surface of valley bottom
118 inclined surface
119 flowing space
120 thin-film state metal lath
121 metal lath before processing
122 through-hole
123 meshed line part
124 strand
125 bond
130 laminated body
131 coil structural body
140 region where incision part is not formed
a object to be treated
b superheated steam

1. An oil removal system by superheated steam, comprising:
a superheated steam generation device; and
an oil removal device,
wherein the oil removal device provides an ejection portion to apply superheated steam obtained by the superheated steam generation device to an object to be treated having oil on the surface,
wherein a surface temperature of the object to be treated is lower than the superheated steam,
wherein the system is constituted such that dew condensation is generated on the surface of the object to be treated by ejection of the superheated steam from the ejection portion, and the dew condensation is removed from the surface of the object to be treated, whereby the oil on the surface of the object to be treated is removed together with the dew condensation.

2. The oil removal system by superheated steam according to claim 1,
wherein the oil removal device comprises a cooling portion to decrease the temperature of the object to be treated, and
wherein the superheated steam is applied to the object to be treated whose temperature is decreased.

3. The oil removal system by superheated steam according to claim 1,
wherein the oil removal device is provided with a removing portion to inject a removal fluid to the surface of the object to be treated after applying the superheated steam, and
wherein by the injection of the removal fluid, the dew condensation and the oil are removed from the surface of the object to be treated.

4. The oil removal system according to claim 1,
wherein a degreasing device is provided to further apply the superheated steam to the surface of the object to be treated, from which the oil is removed by the oil removal device, and
wherein the system is constituted such that the surface of the object to be treated is heated to equal to or more than evaporation temperature of the oil under a non-oxygen atmosphere by the degreasing device, whereby the oil on the surface of the object to be treated is evaporated to perform the degreasing.

5. A superheated steam generation device, comprising:
a steam generation portion to generate steam by applying heat energy to a liquid water, and
a superheated steam generation portion to generate superheated steam by further applying heat energy to the steam obtained in the steam generation portion,
wherein the steam generation portion provides a water tank to store the water, a heating kettle to heat the water supplied from the water tank, and a heat source for heating water to apply the heat energy to the water in the heating kettle,
wherein the superheated steam generation portion provides a superheating furnace to accommodate the steam, and a heat source for heating steam to apply the heat energy to the steam in the superheating furnace,
wherein the heating kettle provides a steam ejection portion,
wherein the steam ejection portion provides a main channel to feed the steam in the heating kettle to the superheated steam generation portion and a sub channel to feed the steam to the water tank, and
wherein the device is constituted such that the water in the water tank is preliminary heated by the steam from the sub channel.

6. The superheated steam generation device according to claim 5,
wherein at least any one of the heat source for heating water and the heat source for heating steam is provided with a planar heating element,
wherein the planar heating element provides at least any one of a metal foil and a metal lath,
wherein the metal foil provides a waveform structure portion in which a mountain part and a valley part are periodically repeated, the waveform structure portion being constituted by a metal foil providing an incision part and a projection piece projecting from the incision part, and
wherein the metal lath is constituted by a metal mesh body providing a large number of through-holes arranged in a staggered array on a plan view between metal meshed line parts.

7. An oil removing method by superheated steam, comprising the steps of:
using the oil removal system according to claim 1;
generating a superheated steam in the superheated steam generation device, device; and
applying the superheated steam from the ejection portion to an object to be treated having oil on a surface,
wherein by applying the superheated steam to the object to be treated whose temperature is lower than the temperature of the superheated steam, dew condensation is generated on the surface of the object to be treated, and the oil on the surface of the object to be treated is removed together with the dew condensation.

8. The oil removing method by the superheated steam according to claim 7, further comprising the steps of:
lowering the temperature of the object to be treated before the step of applying the superheated steam from the ejection portion, which is to apply the superheated steam to the object to be treated whose temperature is lowered; and
injecting a removal fluid to the surface of the object to be treated after the step of applying the superheated steam from the ejection portion, which is to remove the dew condensation and the oil from the surface of the object to be treated by injection of the removal fluid.

9. The oil removing method by the superheated steam according to claim 8, further comprising the steps of:
further applying the superheated steam to the surface of the object to be treated, from which the oil is removed by the oil removal device; and
heating the object to be treated to equal to or more than an evaporation temperature under a non-oxygen atmosphere,
wherein, by the step of heating, the oil on the surface of the object to be treated is evaporated to perform degreasing.

10. The oil removal system by superheated steam according to claim 2,
wherein the oil removal device is provided with a removing portion to inject a removal fluid to the surface of the object to be treated after applying the superheated steam, and
wherein by the injection of the removal fluid, the dew condensation and the oil are removed from the surface of the object to be treated.

11. The oil removal system according to claim 2,
wherein a degreasing device is provided to further apply the superheated steam to the surface of the object to be treated, from which the oil is removed by the oil removal device, and
wherein the system is constituted such that the surface of the object to be treated is heated to equal to or more than evaporation temperature of the oil under a non-oxygen atmosphere by the degreasing device, whereby the oil on the surface of the object to be treated is evaporated to perform the degreasing.

12. The oil removal system according to claim 3,
wherein a degreasing device is provided to further apply the superheated steam to the surface of the object to be treated, from which the oil is removed by the oil removal device, and
wherein the system is constituted such that the surface of the object to be treated is heated to equal to or more than evaporation temperature of the oil under a non-oxygen atmosphere by the degreasing device, whereby the oil on the surface of the object to be treated is evaporated to perform the degreasing.

13. An oil removing method by superheated steam, comprising the steps of:
using the oil removal system according to claim 2;
generating a superheated steam in the superheated steam generation device; and
applying the superheated steam from the ejection portion to an object to be treated having oil on a surface,
wherein by applying the superheated steam to the object to be treated whose temperature is lower than the temperature of the superheated steam, dew condensation is generated on the surface of the object to be treated, and the oil on the surface of the object to be treated is removed together with the dew condensation.

14. An oil removing method by superheated steam, comprising the steps of:
using the oil removal system according to claim 3;
generating a superheated steam in the superheated steam generation device; and
applying the superheated steam from the ejection portion to an object to be treated having oil on a surface,
wherein by applying the superheated steam to the object to be treated whose temperature is lower than the temperature of the superheated steam, dew condensation is generated on the surface of the object to be treated, and the oil on the surface of the object to be treated is removed together with the dew condensation.

15. An oil removing method by superheated steam, comprising the steps of:
using the oil removal system according to claim 4;
generating a superheated steam in the superheated steam generation device; and
applying the superheated steam from the ejection portion to an object to be treated having oil on a surface,
wherein by applying the superheated steam to the object to be treated whose temperature is lower than the temperature of the superheated steam, dew condensation is generated on the surface of the object to be treated, and the oil on the surface of the object to be treated is removed together with the dew condensation.
